(19) United States
(12) Patent Application Publication
(10) Pub. No.: US 2022/0271406 A1
(43) Pub. Date: Aug. 25, 2022

(54) LITHIUM PRIMARY BATTERY

(71) Applicant: Panasonic Intellectual Property Management Co., Ltd., Osaka-shi, Osaka (JP)

(72) Inventors: Miyuki Nakai, Osaka (JP); Takayuki Nakatsutsumi, Osaka (JP); Atsushi Fukui, Hyogo (JP)

(73) Assignee: Panasonic Intellectual Property Management Co., Ltd., Osaka-shi, Osaka (JP)

(21) Appl. No.: 17/439,959

(22) PCT Filed: Nov. 27, 2019
(86) PCT No.: PCT/JP2019/046286

§ 371 Date: May 12, 2022

(30) Foreign Application Priority Data
Mar. 20, 2019 (JP) 2019-052184

(51) Int. Cl. H01M 50/595; H01M 4/38; H01M 4/40; H01M 6/16; H01M 4/06; H01M 50/571; H01M 50/586

(52) U.S. Cl. CPC H01M 50/595; H01M 4/382; H01M 4/405; H01M 6/168; H01M 4/06; H01M 50/571; H01M 50/586; H01M 2300/0025

(57) ABSTRACT

A lithium primary battery including a battery case, an electrode group housed in the battery case, and a non-aqueous electrolyte. The non-aqueous electrolyte contains a non-aqueous solvent, a solute, and an additive. The electrode group includes a positive electrode, a negative electrode, and a separator interposed therebetween. The negative electrode includes a metal lithium or lithium alloy foil, and has a shape having a longitudinal direction and a lateral direction, with a long tape attached to at least one principal surface of the negative electrode along the longitudinal direction. The tape includes a resin base material and an adhesive layer, and has a width of 0.5 mm to 3 mm. The additive includes a phosphorus compound having a POₙ structure having a phosphorus atom and n oxygen atoms bonded to the phosphorus atom, where n=3 or 4.

### TECHNICAL FIELD

The present invention relates to a lithium primary battery.

### BACKGROUND ART

Electronic devices powered by lithium primary batteries have been used in an increasingly wider range of applications in recent years, and lithium primary batteries have tended to be used for long-term operation of the devices. In a lithium primary battery, a metal lithium or lithium alloy foil (hereinafter, a negative electrode foil) is used as a negative electrode. The negative electrode foil functions as a negative electrode active material as well as a negative electrode current collector. As the lithium in the negative electrode foil is consumed by discharge, the function as the current collector degrades gradually. Consequently, the actual battery capacity tends to be smaller than the design capacity.

Patent Literature 1, relating to a lithium primary battery in which manganese dioxide is used as a positive electrode and a lithium negative electrode is used as a negative electrode, discloses attaching a long narrow tape to the negative electrode along its longitudinal direction. By doing this, the dissolution reaction of the lithium negative electrode under the tape can be suppressed during discharge, and the function as the current collector can be maintained.

Patent Literature 2 discloses containing a silyl group-containing compound having a specific structure in the electrolyte, in order to decrease the gas generation, while maintaining the cycle characteristics of a lithium ion secondary battery,

### CITATION LIST

### Patent Literature

[PTL 1] Japanese Laid-Open Patent Publication No. S61-281466

### [PTL 2] Japanese Laid-Open Patent Publication No. 2016-189327

### SUMMARY OF INVENTION

In the case of the lithium primary battery disclosed in Patent Literature 1, an electrolyte is apt to enter a gap under the adhesive material of the tape. The electrolyte having entered the gap under the adhesive material lowers the adhesive force of the adhesive material and causes the tape to peel and float. With the floated tape, the dissolution reaction of the lithium negative electrode cannot be sufficiently suppressed, and at the end of discharge, the function of the lithium negative electrode as the current collector is impaired, failing to achieve a capacity as designed.

One aspect of the present invention relates to a lithium primary battery, including: a battery case; an electrode group housed in the battery case; and a non-aqueous electrolyte, the non-aqueous electrolyte containing a non-aqueous solvent, a solute, and an additive, the electrode group including a positive electrode, a negative electrode, and a separator interposed between the positive electrode and the negative electrode, the negative electrode including a metal lithium or lithium alloy foil, and having a shape having a longitudinal direction and a lateral direction, with a long tape attached to at least one principal surface of the negative electrode along the longitudinal direction, the tape including a resin base material and an adhesive layer, the tape having a width of 0.5 mm or more and 3 mm or less, the additive including a phosphorus compound having a POₙ structure having a phosphorus atom and n oxygen atoms bonded to the phosphorus atom, where n=3 or 4.

According to the present invention, it is possible to provide a lithium primary battery in which the function of the negative electrode as the current collector can be maintained even at the end of discharge.

### BRIEF DESCRIPTION OF DRAWINGS

FIG. 1 A diagram illustrating a configuration of a negative electrode of a lithium primary battery according to an embodiment of the present invention.

FIG. 2 A front view, partially shown in cross section, of a lithium primary battery according to an embodiment of the present invention.

### DESCRIPTION OF EMBODIMENTS

A lithium primary battery according to the present invention includes a battery case, an electrode group housed in the battery case, and a non-aqueous electrolyte. The non-aqueous electrolyte contains a non-aqueous solvent, a solute, and an additive. The electrode group includes a positive electrode containing manganese dioxide, a negative electrode including metal lithium or a lithium alloy, and a separator interposed between the positive electrode and the negative electrode. The positive electrode and the negative electrode may be wound together with a separator therebetween.

The negative electrode includes a metal lithium or lithium alloy foil and has a shape having a longitudinal direction and a lateral direction. A long tape is attached to at least one principal surface of the negative electrode along the longitudinal direction. The tape includes a resin base material and an adhesive layer. In a region covered with the tape of the negative electrode, the dissolution reaction of the negative electrode can be suppressed during discharge. Therefore, the break and the like of the negative electrode are unlikely to occur even in the end of discharge, and the function as the current collector can be maintained.

When the tape is too wide, however, the dissolution reaction of the negative electrode may be inhibited during discharge, failing to exert a sufficient capacity. In order to obtain a high capacity lithium primary battery, the width of the tape should be 3 mm or less. On the other hand, when the width of the tape is less than 0.5 mm, the function of the negative electrode as the current collector is difficult to maintain. Therefore, the width of the tape is set to 0.5 mm or more and 3 mm or less.

The additive contained in the non-aqueous electrolyte includes a phosphorus compound having a POₙ structure having a phosphorus atom and n oxygen atoms bonded to the phosphorus atom, where n=3 or 4. In short, the phosphorus compound can be an oxy compound having a P—O bond or an oxo compound having a P═O bond. The phosphorus compound may further has a silicon atom bonded to at least one of the oxygen atoms bonded to the phosphorus atom (i.e., P—O—Si bond).

The phosphorus compound can act to inhibit the entry of the non-aqueous electrolyte into a gap under the adhesive layer of the tape. Although the detailed mechanism is unclear, this is presumably because the phosphorus compound and the component contained in the adhesive layer of the tape cause some reaction or interaction therebetween, improving the adhesion. Such a reaction or interaction is considered to involve the cleavage of a P—O bond, a P—O—Si bond, and other bonds. Therefore, a gap is unlikely to be formed between the negative electrode and the adhesive layer due to the reduction in adhesion therebetween, and the floating-up of the resin base material of the tape can be suppressed. Thus, in a region covered with the tape of the negative electrode, the dissolution by discharge can be suppressed over a long period of time.

The phosphorus compound may be, for example, at least one selected from the group consisting of phosphoric acid, phosphorous acid, a phosphate ester, a phosphite ester, a silyl phosphate ester, and a silyl phosphite ester. Among these, at least one selected from the group consisting of a silyl phosphate ester and a silyl phosphite ester can effectively suppress the reduction in adhesion between the negative electrode and the adhesive layer. As for the phosphoric acid, the phosphorous acid, and the like, the P—OH group may be dissociated in the non-aqueous electrolyte, forming a P—O⁻ anion.

The phosphorus compound can be at least one selected from the group consisting of the following first to fourth compounds.

The first compound is represented by a formula (1):

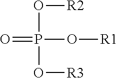

The second compound is represented by a formula (2):

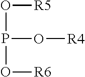

The third compound is represented by a formula (3):

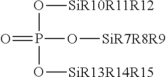

The fourth compound represented by a formula (4):

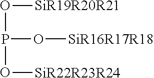

In the formulas (1) to (4), each of R1 to R24 may be independently a hydrogen atom, a saturated aliphatic group, an unsaturated aliphatic group, or an aromatic group. In view of the oxidation resistance, at least one hydrogen atom in each of the saturated aliphatic group, the unsaturated aliphatic group, and the aromatic group may be substituted by a fluorine atom. Two groups may be bonded together to form a ring. R1 to R6 are all bonded to an oxygen atom, and R7 to R24 are all bonded to a silicon atom.

The saturated aliphatic group is preferably an alkyl group, particularly preferably a C1 to C6 alkyl group, and may be a C1 to C3 alkyl group. At least one hydrogen atom of the alkyl group may be substituted by a fluorine atom, and a perfluoroalkyl group may be used. Specific examples thereof include a methyl group, an ethyl group, an n-propyl group, an iso-propyl group, an n-butyl group, an iso-butyl group, a sec-butyl group, a tert-butyl group, a fluoromethyl group, and a fluoroethyl group. The saturated aliphatic group is preferably an alkenyl group, examples of which include a vinyl group, an allyl group, and a 1-methylvinyl group. Examples of the aromatic group include a benzyl group, a phenyl group, and a fluorophenyl group.

Preferred is a saturated aliphatic group, and particularly preferred are a methyl group, an ethyl group, and the like. To be specific, in the formula (1), R1 to R3 may all represent a saturated aliphatic group, in the formula (2), R4 to R6 may all represent a saturated aliphatic group, in the formula (3), R7 to R15 may all represent a saturated aliphatic group, and in the formula (4), R16 to R24 may all represent a saturated aliphatic group.

In the formula (1), R1 to R3 may all represent the same group, in the formula (2), R4 to R6 may all represent the same group, in the formula (3), R7 to R15 may all represent the same group, and in the formula (4), R16 to R24 may all represent the same group. For example, in the formula (1), R1 to R3 may all represent a methyl group, in the formula (2), R4 to R6 may all represent a methyl group, in the formula (3), R7 to R15 may all represent a methyl group, and in the formula (4), R16 to R24 may all represent a methyl group.

Examples of the first compound include phosphoric acid, trimethylphosphate, triethyl phosphate, and tris(2,2,2-trifluoroethyl) phosphate. Examples of the second compound include phosphorous acid, trimethyl phosphite, triethyl phosphite, and tris(2,2,2-trifluoroethyl) phosphite. Examples of the third compound include tris(trimethylsilyl) phosphate, and tris(triethylsilyl) phosphate. Examples of the fourth compound include tris(trimethylsilyl) phosphite, and tris(triethylsilyl) phosphite. Among them, tris(trimethylsilyl) phosphate (O═P(O—Si(CH₃)₃)₃) (hereinafter sometimes referred to as TTSPa) and tris(trimethylsilyl) phosphite (P(O—Si(CH₃)₃)₃) (hereinafter sometimes referred to as TTSPi) are preferred because they have a S—O—Si bond which is rich in reactivity.

The content of the phosphorus compound in the non-aqueous electrolyte is, for example, 0.002 mol/L or more, and may be 0.01 mol/L or more, and may be 0.1 mol/L or more. For good dissolution of the phosphorus compound in the non-aqueous electrolyte, the content of the phosphorus compound in the non-aqueous electrolyte is preferably 1.0 mol/L or less, and may be 0.5 mol/L or less, and may be 0.3 mol/L or less.

Next, a description will be given of a tape including a resin base material and an adhesive layer.

Examples of the resin base material include fluorocarbon resin, polyimide, polyphenylene sulfide, polyethersulfone, a polyolefin such as polyethylene and polypropylene, and polyethylene terephthalate. Preferred among them is a polyolefin, and more preferred is polypropylene.

The adhesive layer contains, for example, at least one component selected from the group consisting of a rubber component, a silicone component, and an acrylic resin component. Specifically, the rubber component may be a synthetic rubber, a natural rubber, and the like. Examples of the synthetic rubber include butyl rubber, butadiene rubber, styrene-butadiene rubber, isoprene rubber, neoprene, polyisobutylene, acrylonitrile-butadiene rubber, styrene-isoprene block copolymer, styrene-butadiene block copolymer, and styrene-ethylene-butadiene block copolymer. Examples of the silicone component include an organic compound having a polysiloxane structure, and a silicone-containing polymer. The silicone-containing polymer is exemplified by a peroxide curing type silicone, and an addition reaction type silicone. The acrylic resin component may be a polymer having an acrylic monomer, such as acrylic acid, methacrylic acid, acrylic acid ester, and methacrylic acid ester, which may be in the form of a homopolymer or a copolymer of acrylic monomers, such as acrylic acid, methacrylic acid, methyl acrylate, methyl methacrylate, ethyl acrylate, ethyl methacrylate, propyl acrylate, propyl methacrylate, butyl acrylate, butyl methacrylate, octyl acrylate, octyl methacrylate, 2-ethyl hexyl acrylate, and 2-ethylhexyl methacrylate. The adhesive layer may further contain a crosslinking agent, a plasticizer, and/or a tackifier.

The tape may have a width of 0.5 mm or more, but in view of appropriately suppressing the dissolution by discharge of the negative electrode covered with the tape, the width is preferably 1 mm or more, more preferably 1.5 mm or more. The width of the tape may be 3 mm or less, but in view of sufficiently suppressing the decrease in the battery discharge capacity (output capacity), the width is preferably 2.5 mm or less, more preferably 2 mm or less. The tape may be attached to one side or both sides of the negative electrode.

In one embodiment of the present invention, a ratio: Sₜ/Sₙ multiplied by 100 of an area Sₜ of the tape to an area Sₙ of the negative electrode is desirably 0.5% or more and 4% or less. Here, the area Sₙ of the negative electrode refers to a width Wₙ multiplied by a length Lₙ of the negative electrode, which is expressed by Sₙ=Wₙ·Lₙ. The area Sₜ of the tape refers to a width Wₜ multiplied by a length Lₜ of the tape, which is expressed by Sₜ=Wₜ·Lₜ. When the Sₜ/Sₙ multiplied by 100 is 0.5% or more, the dissolution by discharge of the negative electrode covered with the tape can be more effectively suppressed. When the Sₜ/Sₙ multiplied by 100 is 4% or less, the decrease in the battery discharge capacity (output capacity) can be more sufficiently suppressed.

In one embodiment of the present invention, the non-aqueous electrolyte may contain at least one kind of a solvent having a viscosity of 1 mPa·s or less. This can improve the discharge characteristics of the lithium primary battery. The solvent is preferably, for example, dimethoxyethane. The dimethoxyethane content by volume in the solvent is preferably 5% to 80%.

Embodiments of the present invention will be specifically described below. The following embodiments, however, are merely part of concrete examples of the present invention and are not intended to limit the scope of the invention.

(Positive Electrode)

The positive electrode active material includes at least one selected from the group consisting of manganese oxide and a fluorinated graphite. For the positive electrode active material, manganese dioxide may be used singly or by mixing with a manganese oxide or a fluorinated graphite. A battery containing manganese dioxide develops a relatively high voltage and is excellent in pulse discharge characteristics. Preferred as the manganese dioxide is an electrolytic manganese dioxide prepared through neutralization with ammonia, sodium, lithium, or the like. More preferred is a baked electrolytic manganese dioxide prepared through subsequent baking. Specifically, it is preferable to bake an electrolytic manganese dioxide in air or in oxygen at 300 to 450° C. for about 6 to 12 hours. The oxidation number of the manganese in the manganese dioxide is typically four, but not limited thereto, and may be somewhat larger or smaller than this number. The manganese dioxide that can be used is, for example, MnO, Mn₃O₄, Mn₂O₃, MnO₂, MnO₃, and the like, and typically, the manganese dioxide is used as a main component. The manganese dioxide may be in a mixed crystal state including two or more kinds of crystals. When using an unbaked electrolytic manganese dioxide, preferred is a manganese dioxide with a reduced specific surface area, which can be obtained by increasing the crystallinity by adjusting the conditions at the time of electrolytic synthesis. Moreover, a small amount of a chemical manganese dioxide, manganese dioxide, and the like can be added.

The positive electrode includes a positive electrode material mixture layer containing a positive electrode active material, and a positive electrode current collector with the positive electrode material mixture layer attached thereto. The positive electrode material mixture layer is formed, for example, on one side or both sides of a sheet-like positive electrode current collector (e.g., expanded metal, net, punching metal) such that the positive electrode current collector is embedded. The positive electrode current collector may be made of, for example, stainless steel, aluminum, or titanium. The positive electrode material mixture layer can contain, in addition to the positive electrode active material, a resin material, such as fluorocarbon resin, as a binder. The positive electrode material mixture layer may include an electrically conductive material, such as a carbon material, as a conductive agent.

The binder may be, for example, a fluorocarbon resin, rubber particles, an acrylic resin, and the like. Examples of the fluorocarbon resin include polytetrafluoroethylene, tetrafluoroethylene-hexafluoropropylene copolymer, and polyvinylidene fluoride. Examples of the rubber particles include styrene-butadiene rubber (SBR) and modified acrylonitrile rubber. Examples of the acrylic resin include ethylene-acrylic acid copolymer. The binder is contained in the positive electrode material mixture in an amount of preferably 10 to 25 mass %, more preferably 12 to 23 mass %, further more preferably 15 to 20 mass %. These binders may be used singly or in combination of two or more kinds.

The conductive agent may be, for example, natural graphite, artificial graphite, carbon black, carbon fibers, and the like. Examples of the carbon black include acetylene black, Ketjen black, channel black, furnace black, lamp black, and thermal black. These may be used singly or in combination of two or more kinds. The conductive agent is contained in the positive electrode material mixture in an amount of, for example, 1 to 30 parts by mass per 100 parts by mass of the positive electrode active material.

The positive electrode is produced, for example, as follows.

First, manganese dioxide, an electrically conductive agent, and a binder are mixed together, to prepare a positive electrode material mixture. The mixing method of the manganese dioxide, the conductive agent, and the binder is not specifically limited. For example, a material mixture obtained by mixing manganese dioxide, a conductive agent, and a binder in a dry or wet process is packed onto an expanded metal made of stainless steel serving as a current collector, followed by pressing them between rollers, and then cutting in predetermined size. In this way, a positive electrode can be obtained.

(Negative Electrode)

For the negative electrode, for example, metal lithium and a lithium alloy, such as Li—Al, Li—Sₙ, Li—NiSi, and Li—Pb, may be used. These materials formed into a sheet may be used as it is, as the negative electrode plate. A preferred lithium alloy is a Li—Al alloy. The content of the metal element(s) other than lithium contained in the lithium alloy is preferably 0.05 to 15 mass %, in view of securing of the discharge capacity and stabilizing the internal resistance. The metal lithium or the lithium alloy is formed in a desired shape and thickness, according to the shape, dimensions, design performance, and others of the lithium primary battery.

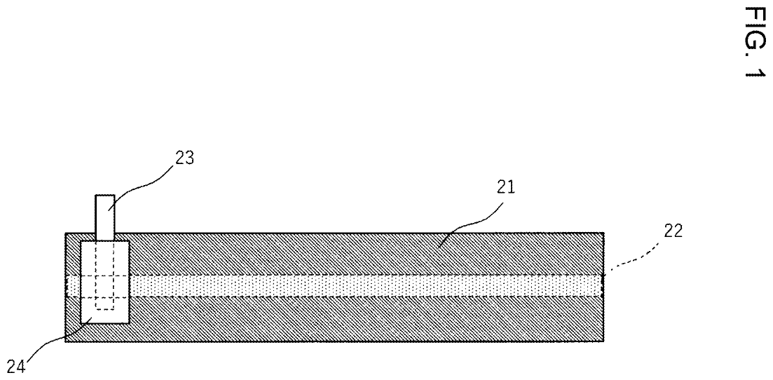

FIG. 1 is a diagram illustrating a configuration of a negative electrode of a lithium primary battery according to one embodiment of the present invention. A negative electrode 21 has a belt-like shape having a longitudinal direction and a lateral direction. A long tape 22 is attached on one principal surface of the negative electrode 21 along the longitudinal direction. The tape 22 includes a resin base material and an adhesive layer, and the width of the tape 22 is 0.5 mm or more and 3 mm or less. A negative electrode lead 23 for taking out current is fixed to the negative electrode 21 at its one end in the longitudinal direction. At the one end of the negative electrode 21 in the longitudinal direction at which the negative electrode lead 23 is fixed, a lead protective tape 24 is attached. FIG. 1 shows the case where the tape 22 is attached on the back side of the negative electrode 21.

(Separator)

The separator may be a porous sheet formed of an electrically insulating material having resistance against the internal environment of the lithium primary battery. Specific examples thereof include a nonwoven fabric made of synthetic resin and a microporous film made of synthetic resin. Examples of the synthetic resin used for the nonwoven fabric include polypropylene, polyphenylene sulfide, and polybutylene terephthalate. Among them, polyphenylene sulfide and polybutylene terephthalate are excellent in high-temperature resistance, solvent resistance, and electrolyte-retaining ability. Examples of the synthetic resin used for the microporous film include a polyolefin resin, such as polyethylene, polypropylene, and ethylene-propylene copolymer. The microporous film may contain inorganic particles, if necessary. The thickness of the separator is preferably, for example, 5 μm or more and 100 μm or less.

(Non-Aqueous Electrolyte)

The non-aqueous electrolyte contains a non-aqueous solvent and a lithium salt dissolved as a solute in the non-aqueous solvent. An additive can be further contained, if necessary. The non-aqueous solvent may be a typical organic solvent used in a non-aqueous electrolyte of a lithium primary battery, such as dimethyl ether, γ-butyl lactone, propylene carbonate, ethylene carbonate, and 1,2-dimethoxyethane. These may be used singly or in combination of two or more kinds. In view of improving the discharge characteristics of the lithium primary battery, the non-aqueous solvent preferably includes a cyclic carbonic acid ester having a high boiling point and a chain ether having a low viscosity even at low temperatures. The cyclic carbonic acid ester preferably includes at least one selected from the group consisting of propylene carbonate (PC) and ethylene carbonate (EC), and particularly preferably includes PC. The chain ether preferably has a viscosity of 1 mPa·s or less at 25° C., and particularly preferably includes dimethoxyethane (DME). The viscosity of the non-aqueous solvent can be measured using a small sample viscometer m-VROC available from RheoSense, Inc., in a 25° C. environment, at a shear rate of 10,000 (1/s).

The solute can include a lithium salt, such as LiCF₃SO₃, LiClO₄, LiBF₄, LiPF₆, LiRaSO₃, where Ra is a fluorinated alkyl group having one to four carbon atoms, LiFSO₃, LiN(SO₂Rb)(SO₂Rc), where each of Rb and Rc is independently a fluorinated alkyl group having one to four carbon atoms, LiN(FSO₂)₂, and LiPO₂F₂. These may be used singly or in combination of two or more kinds. The total concentration of the lithium salt contained in the non-aqueous electrolyte is preferably 0.2 to 2.0 mol/L, which may be 0.3 to 1.5 mol/L, and may be 0.4 to 1.2 mol/L.

The non-aqueous electrolyte can contain, in addition to the aforementioned materials, a second additive, such as phthalimide, propane sultone, and vinylene carbonate. The hydrogen in the second additive may be partially substituted by a hydroxy group, a halogen group, an alkyl group, or the like. These second additives may be used singly or in combination of two or more kinds. In view of improving the battery stability, the second additive preferably includes at least phthalimide. The total concentration of the second additive contained in the non-aqueous electrolyte is preferably 0.003 to 5 mol/L, more preferably 0.003 to 3 mol/L.

(Cylindrical Battery)

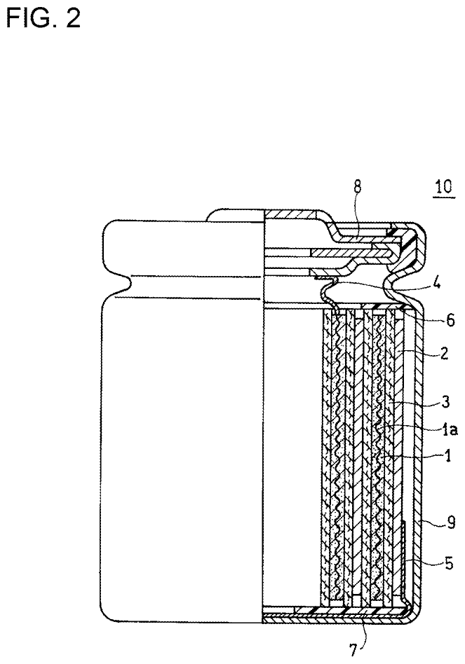

FIG. 2 is a front view, partially shown in cross section, of a lithium primary battery according to one embodiment of the present invention. In the lithium primary battery, an electrode group 10 formed by winding a positive electrode 1 and a negative electrode 2, with a separator 3 interposed therebetween, is housed together with a non-aqueous electrolyte (not shown) in a battery case 9. A sealing plate 8 is placed at the opening of the battery case 9. A positive electrode lead 4 connected to a current collector 1a of the positive electrode 1 is connected to the sealing plate 8. A negative electrode lead 5 connected to the negative electrode 2 is connected to the case 9. On the upper side and the lower side of the electrode group 10, an upper insulating plate 6 and a lower insulating plate 7 are disposed, respectively, for preventing internal short-circuit.

The present invention will be more specifically described below with reference to Examples. It is to be noted, however, the present invention is not limited to the following Examples. In the present Examples, cylindrical lithium primary batteries having a structure as illustrated in FIG. 2 were produced.

### Examples 1 to 8 and Comparative Examples 1 to 15

(1) Positive Electrode

To 100 parts by mass of manganese dioxide serving as a positive electrode active material, 5 parts by mass of Ketjen black serving as a conductive agent, and 5 parts by mass of polytetrafluoroethylene serving as a binder were added and mixed together, to prepare a positive electrode material mixture.

Next, the positive electrode material mixture was passed, together with a positive electrode current collector of a 0.1-mm-thick expanded metal made of ferritic stainless steel (SUS430), between a pair of rolls rotating at a consistent speed, to pack the positive electrode material mixture into the tiny holes in the expanded metal. This was followed by drying, then rolling with a roll press until the thickness reached 0.4 mm, and cutting in a predetermined size (width: 45 mm, length: 165 mm), to give a positive electrode plate. The positive electrode material mixture was removed form a part of the positive electrode plate, to expose the positive electrode current collector. A positive electrode lead was welded to the exposed part. To the upper portion of the positive electrode lead, a lead protective tape was attached for the purpose of preventing short circuit.

(2) Negative Electrode

A 0.15-mm-thick metal lithium plate cut in a predetermined size (width: 42 mm, length: 190 mm) was used as a negative electrode plate. A negative electrode lead was connected to the negative electrode plate. To the upper portion of the negative electrode lead, too, a lead protective tape was attached for the purpose of preventing short circuit. A long tape was attached to the negative electrode on its one side or both sides along the longitudinal direction. The long tape included a resin base material made of a 40-μm-thick polypropylene and an adhesive layer mainly composed of a rubber, and had a width as shown in Table 1.

(3) Electrode Group

The positive electrode plate and the negative electrode plate were spirally wound, with a 25-μm-thick microporous film made of polypropylene interposed therebetween as a separator, to form a columnar electrode group.

(4) Non-Aqueous Electrolyte

Propylene carbonate (PC), ethylene carbonate (EC), and 1,2-dimethoxyethane (DME) were mixed in a volume ratio of 4:2:4, to prepare a non-aqueous solvent. The non-aqueous solvent was used to prepare a non-aqueous electrolyte containing LiCF₃SO₃ as a solute at a concentration of 0.5 mol/L.

Furthermore, in the prepared non-aqueous electrolyte, except in some Comparative Examples, a phosphorus compound as shown in Table 1 was added as an additive. To be specific, tris(trimethylsilyl) phosphate (P═(O—Si(CH₃)₃)₃) (TTSPa) or tris(trimethylsilyl) phosphite (P(O—Si(CH₃)₃)₃) (TTSPi) was added. The content of the phosphorus compound in the non-aqueous electrolyte was set to 0.2 mol/L.

(5) Assembling of Cylindrical Battery

The obtained electrode group was inserted, together with a ring-shaped lower insulating plate placed at its bottom, into a bottomed cylindrical battery case. Thereafter, the positive lead 4 connected to the positive electrode current collector of the positive electrode plate was connected to the inner surface of a sealing plate, and the negative lead connected to the negative electrode plate was connected to the inner bottom surface of the battery case.

Next, the non-aqueous electrolyte was injected into the battery case, and an upper insulating plate was placed on the electrode group. Thereafter, the opening of the battery case was sealed with the sealing plate, thereby to complete a cylindrical lithium primary battery having a diameter of 14 mm and a height of 50 mm, as illustrated in FIG. 2. Batteries A1 to A8 correspond to Examples 1 to 8, respectively, and batteries B1 to B15 correspond to Comparative Examples 1 to 15, respectively.

[Evaluation]

Ten batteries each from the fabricated batteries A1 to A8 and B1 to B15 were each subjected to a constant-resistance discharge (1 kΩ), to measure the discharge capacity until reaching 2 V, and then determine how much the actual discharge capacity increased or decreased in percentage from the design capacity. The average of the 10 batteries was calculated. The results are shown in Table 1. When a lithium break was observed in some of the 10 batteries, the average of the remaining batteries was calculated. When a lithium break was observed in all of the 10 batteries, it is denoted as ND.

The battery having been subjected to the above discharge was disassembled, to check the presence or absence of a break in the negative electrode. In Table 1, the “lithium break” is rated as follows.

∘: None of the 10 batteries had a lithium break.

Δ: Some of the 10 batteries had a lithium break.

x: All of the 10 batteries had a lithium break.

TABLE 1

| | | Tape | | | Capacity vs. |
|---|---|---|---|---|---|
| | Tape | width | Phosphorus | Lithium | design value |
| Battery | placement | (mm) | compound | break | (%) |
| A1 | One side | 3 | TTSPa | ○ | 0 |
| A2 | One side | 3 | TTSPi | ○ | 0 |
| A3 | One side | 2 | TTSPa | ○ | 0.51 |
| A4 | One side | 2 | TTSPi | ○ | 0.47 |
| A5 | One side | 0.5 | TTSPa | ○ | 0.2 |
| A6 | One side | 0.5 | TTSPi | ○ | 0.22 |
| A7 | Both sides | 0.5 | TTSPa | ○ | 0.1 |
| A8 | Both sides | 0.5 | TTSPi | Δ | 0.1 |
| B1 | One side | 5 | TTSPa | ○ | −1 |
| B2 | One side | 5 | TTSPi | ○ | −1 |
| B5 | One side | 5 | Without | ○ | −1 |
| B3 | One side | 4 | TTSPa | ○ | −1 |
| B4 | One side | 4 | TTSPi | ○ | −1 |
| B6 | One side | 4 | Without | ○ | −1 |
| B7 | One side | 3 | Without | Δ | 0 |
| B8 | One side | 2 | Without | x | ND |
| B9 | Both sides | 0.5 | Without | x | ND |
| B10 | Both sides | 4 | TTSPa | ○ | −2.5 |
| B11 | Both sides | 4 | TTSPi | ○ | −2.3 |
| B12 | Both sides | 4 | Without | ○ | −2.2 |
| B13 | Both sides | 0.5 | Without | x | ND |
| B14 | None | — | TTSPa | x | ND |
| B15 | None | — | TTSPi | x | ND |

Table 1 shows that when the tape was placed on one side of the negative electrode, the tape width was set to 0.5 mm or more and 3 mm or less, and an additive was added in the non-aqueous electrolyte, no lithium beak occurred, and the capacity versus design value showed no decrease. In contrast, in Comparative Examples, the capacity was decreased to be lower than the design value in most of the batteries.

Placing the tape on both sides of the negative electrode may be an easy way to make the negative electrode keep functioning as a current collector. However, when the tape(s) is displaced, this increases the area that inhibits the negative electrode reaction, and the output capacity versus design value decreases. Furthermore, when winding the electrode plates, the electrode plates are stretched. In the case of placing the tape on both sides, as compared to placing on one side, it is difficult to relax the stretching stress. The tape is therefore easily peeled off or separated from the negative electrode when winding. From the foregoing, more preferably, the tape is placed on only one side of the negative electrode.

Next, the peeling strength between the tape and the negative electrode after immersed in the non-aqueous electrolyte was evaluated.

### Reference Examples 1 to 15

A 0.15-mm-thick metal lithium plate was cut in a predetermined size (width: 42 mm, length: 195 mm), to which a long tape was attached along the longitudinal direction of the lithium plate, to prepare a test piece. The long tape included a resin base material made of a 40-μm-thick polypropylene, and an adhesion layer mainly composed of the material as shown in Table 2. The tape width was set to 10 mm.

Propylene carbonate (PC), ethylene carbonate (EC), and dimethoxyethane (DME) were mixed in a volume ratio of 4:2:4, to prepare a non-aqueous solvent. This non-aqueous solvent was used to prepare non-aqueous electrolytes C1 to C15 containing LiCF₃SO₃ as a solute at a concentration of 0.5 mol/L, and with some exceptions, containing an additive as shown in Table 2, i.e., TTSPa, TTSPi, PS (propane sultone), or VC (vinylene carbonate), at a concentration of 0.2 mol/L. The non-aqueous electrolytes C1 to C15 correspond to Reference Examples 1 to 15, respectively.

The prepared test piece was measured for the peeling strength between the metal lithium plate and the tape. The peeling strength was measured by a 90-degree peeling test in accordance with JIS K 6854, with respect to 10 test pieces after immersed for one hour in each of the 25° C. non-aqueous electrolytes C1 to C15, and 10 test pieces not immersed in the non-aqueous electrolyte. With the averaged peeling strength of the test pieces not immersed in the non-aqueous electrolyte denoted by F1, and the averaged peeling strength of the test pieces after immersed in the non-aqueous electrolyte denoted by F2, the percentage in change in the peeling strength from F1 to F2 was determined. The results are shown in Table 2.

TABLE 2

| | | | Percentage in |
|---|---|---|---|
| | | | change in |
| Non-aqueous | Adhesive | | peeling strength |
| electrolyte | material | Additive | (%) |
| C1 | Rubber | TTSPa | 0 |
| C2 | Silicone | TTSPa | 1 |
| C3 | Acrylic resin | TTSPa | 0 |
| C4 | Rubber | TTSPi | 0 |
| C5 | Silicone | TTSPi | 1 |
| C6 | Acrylic resin | TTSPi | 1 |
| C7 | Rubber | Without | −40 |
| C8 | Silicone | Without | −38 |
| C9 | Acrylic resin | Without | −24 |
| C10 | Rubber | PS | −33 |
| C11 | Silicone | PS | −30 |
| C12 | Acrylic resin | PS | −28 |
| C13 | Rubber | VC | −37 |
| C14 | Silicone | VC | −38 |
| C15 | Acrylic resin | VC | −30 |

Table 2 shows that when the additive used in the non-aqueous electrolyte was a phosphorus compound, the peeling strength between the negative electrode and the tape remained almost unchanged, regardless of what material was used for the adhesive material of the tape. In contrast, when no additive was used, or the additive was a cyclic sultone derivative (e.g., PS) or a cyclic carbonic ester (e.g., VC), which were conventionally known as an additive for improving the high temperature storage characteristics in a non-aqueous electrolyte battery, the peeling strength was considerably reduced.

### INDUSTRIAL APPLICABILITY

The lithium primary battery according to the present invention can be suitably used for long-term operation of the devices. The lithium primary battery according to the present invention is applicable to, for example, a gas meter, a water meter, and the like.

### REFERENCE SIGNS LIST

1 positive electrode
1a positive electrode current collector
2, 21 negative electrode
3 separator
4 positive electrode lead
5, 23 negative electrode lead
6 upper insulating plate
7 lower insulating plate
8 sealing plate
9 battery case
10 electrode group
22 tape
24 lead protective tape

1. A lithium primary battery, comprising:
a battery case; an electrode group housed in the battery case; and a non-aqueous electrolyte,
the non-aqueous electrolyte containing a non-aqueous solvent, a solute, and an additive,
the electrode group including a positive electrode, a negative electrode, and a separator interposed between the positive electrode and the negative electrode,
the negative electrode including a metal lithium or lithium alloy foil, and having a shape having a longitudinal direction and a lateral direction, with a long tape attached to at least one principal surface of the negative electrode along the longitudinal direction,
the tape including a resin base material and an adhesive layer,
the tape having a width of 0.5 mm or more and 3 mm or less,
the additive including a phosphorus compound having a POₙ structure having a phosphorus atom and n oxygen atoms bonded to the phosphorus atom, where n=3 or 4.

2. The lithium primary battery according to claim 1, wherein the phosphorus compound further contains a silicon atom bonded to at least one of the oxygen atoms.

3. The lithium primary battery according to claim 1, wherein the phosphorus compound is at least one selected from the group consisting of phosphoric acid, phosphorous acid, a phosphate ester, a phosphite ester, a silyl phosphate ester, and a silyl phosphite ester.

4. The lithium primary battery according to claim 3, wherein
the phosphorus compound is at least one selected from the group consisting of a first compound represented by a formula (1): 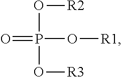
a second compound represented by a formula (2): 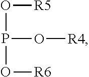
a third compound represented by a formula (3): 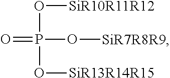
and
a fourth compound represented by a formula (4): 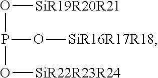
in the formulas (1) to (4), each of R1 to R24 is independently a hydrogen atom, a saturated aliphatic group, an unsaturated aliphatic group, or an aromatic group, and at least one hydrogen atom in each of the saturated aliphatic group, the unsaturated aliphatic group, and the aromatic group may be substituted by a fluorine atom.

5. The lithium primary battery according to claim 4, wherein in the formulas (1) to (4), R1 to R24 all represent a saturated aliphatic group.

6. The lithium primary battery according to claim 4 or 5, wherein
in the formula (1), R1 to R3 all represent the same group,
in the formula (2), R4 to R6 all represent the same group,
in the formula (3), R7 to R15 all represent the same group, and/or
in the formula (4), R16 to R24 all represent the same group.

7. The lithium primary battery according to any one of claims 4 to 6, wherein
in the formulas (1) to (4), R1 to R24 all represent a methyl group.

8. The lithium primary battery according to claim 1 or 2, wherein the phosphorus compound is tris(trimethylsilyl) phosphate (O═P(O—Si(CH₃)₃)₃) and/or tris(trimethylsilyl) phosphite (P(O—Si(CH₃)₃)₃).

9. The lithium primary battery according to any one of claims 1 to 8, wherein a content of the phosphorus compound in the non-aqueous electrolyte is 0.002 mol/L or more and 1.0 mol/L or less.

10. The lithium primary battery according to any one of claims 1 to 9, wherein the resin base material of the tape includes a polyolefin.

11. The lithium primary battery according to any one of claims 1 to 10, wherein the adhesive layer of the tape includes at least one selected from the group consisting of a rubber component, a silicone component, and an acrylic resin component.

12. The lithium primary battery according to any one of claims 1 to 11, wherein a ratio: Sₜ/Sₙ multiplied by 100 of an area Sₜ of the tape to an area Sₙ of the negative electrode is 0.5% or more and 4% or less.

13. The lithium primary battery according to any one of claims 1 to 12, wherein the non-aqueous electrolyte contains at least one kind of a solvent having a viscosity of 1 mPa·s or less at 25° C.

14. The lithium primary battery according to claim 13, wherein the solvent includes dimethoxyethane.

15. The lithium primary battery according to any one of claims 1 to 14, wherein the non-aqueous electrolyte includes phthalimide.
